(19) United States
(12) Patent Application Publication
(10) Pub. No.: US 2012/0310941 A1
(43) Pub. Date: Dec. 6, 2012

(54) SYSTEM AND METHOD FOR WEB-BASED CONTENT CATEGORIZATION

(75) Inventors: Roderick William MacDonald, Ottawa (CA); Hao Tang, Saratoga, CA (US); Haijun Cao, Belmont, CA (US); Kumaran Sangareddi, Cupertino, CA (US)

(73) Assignee: KINDSIGHT, INC., Sunnyvale, CA (US)

(21) Appl. No.: 13/152,175

(22) Filed: Jun. 2, 2011

(51) Int. Cl. G06F 17/30

(52) U.S. Cl. 707/740; 707/E17.09

(57) ABSTRACT

A web mapping system and method are described. The web map system receives a content pointer and provides a category result associated with the content pointer. The category result is determined by successively selecting and applying one of a plurality of categorization algorithms that each attempt to provide a category result for a URL based on a plurality of rules. If no category result is determined, the content pointer may be passed to a categorization manager to generate a rule for the content pointer so that subsequent categorization requests for the content pointer will result in a category result.

### TECHNICAL FIELD

The current application relates to the field of content categorization and in particular to a system and method for categorizing web-based content and providing categorizations based on a content pointer.

### BACKGROUND

Content on the Internet can be identified by a uniform resource locator (URL) which identifies where the content can be retrieved from. A computing device may retrieve the content from a particular URL for display on a computing device by sending a request for the URL through an Internet Service Provider (ISP). The retrieved content may include an indication for the inclusion of an advertisement. The specific advertisement that is displayed may be retrieved separately from the main content. For example an advertising network may provide specific advertisements to be displayed with retrieved content. The advertisement provided by the advertising network may be determined in various ways, including based on the main content being viewed or a profile associated with the computing device requesting device or an ISP account associated with the computing device viewing the content. The ISP account may be associated with providing internet access for one or more computing devices in a household. A plurality of household computing devices may use the same ISP account by connecting to a shared ISP access device such as a modem.

Various techniques may be used to determine a category associated with content. For example, the main content may be processed to determine keywords in the content and provide categories based on the keywords. The categories associated with particular content may be used to tailor the advertisements delivered with the content. Additionally or alternatively, the category information may be used to update a profile associated with the computing device or ISP account.

Although systems and methods exist for tailoring advertisements or updating profiles based on a category associated with requested content, it is desirable to have a system and method that can efficiently generate and provide the category information associated with the requested content.

### SUMMARY

In accordance with the present disclosure there is provided a system for categorizing web pages comprising a memory unit for storing instructions and a processing unit for executing instructions stored in the memory unit. The instructions, when executed by the processing unit configure the processing system to provide a plurality of rules, each rule comprising a matching expression and associated categorization information; a plurality of categorization algorithms, each of the categorization algorithms for providing a category result for a content pointer indicating a particular content according to one of the plurality of rules, the category result based on categorization information of a rule having a matching expression that matches the content pointer; and a lookup component for receiving a requested URL and successively selecting a categorization algorithm from the plurality of categorization algorithms to apply to the requested content pointer until one of the plurality of categorization algorithms provides a category result for the content pointer.

In accordance with the present disclosure there is further provided a method for categorizing web pages comprising: receiving a universal resource locator (content pointer) request for categorization; selecting a first categorization algorithm from a plurality of categorization algorithms, each of the categorization algorithms for providing a category result for a universal resource locator (content pointer) according to one of a plurality of rules, each rule comprising a matching expression and associated categorization information; applying the selected first categorization algorithm to the requested content pointer; determining if the selected first categorization algorithm provided a category result for the requested content pointer; and selecting an other categorization algorithm to apply to the requested content pointer when it is determined that the first categorization algorithm did not provide the category result.

In accordance with the present disclosure there is further provided a computer readable memory comprising instructions for providing a method for categorizing web pages. The method comprises receiving a content pointer request for categorization; selecting a first categorization algorithm from a plurality of categorization algorithms, each of the categorization algorithms for providing a category result for a content pointer according to one of a plurality of rules, each rule comprising a matching expression and associated categorization information; applying the selected first categorization algorithm to the requested content pointer; determining if the selected first categorization algorithm provided a category result for the requested content pointer; and selecting an other categorization algorithm to apply to the requested content pointer when it is determined that the first categorization algorithm did not provide the category result.

### BRIEF DESCRIPTION OF THE DRAWINGS

Embodiments are described herein with references to the appended drawings, in which:

FIG. 1 depicts in a block diagram an illustrative system for categorizing web pages used in an advertising environment;

FIG. 2 depicts in a block diagram an illustrative lookup component that may be used in a system for categorizing web pages;

FIG. 3 depicts in a block diagram an illustrative categorization manager that may be used in a system for categorizing web pages;

FIG. 4 depicts in a flow chart an illustrative method of categorizing web pages;

FIG. 5 depicts in a block diagram a distributed system for categorizing web pages;

FIG. 6 depicts in a process flow diagram an illustrative categorization process in a distributed system for categorizing web pages; and

FIG. 7 depicts in a process flow diagram a further illustrative categorization process in a distributed system for categorizing web pages.

### DETAILED DESCRIPTION

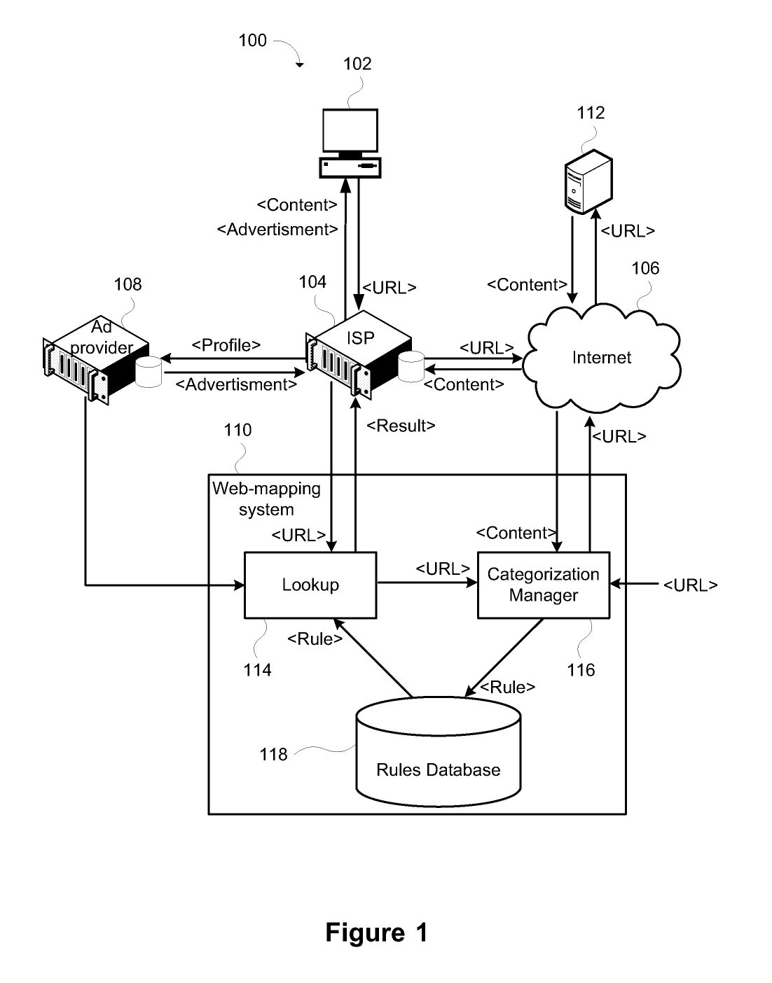

FIG. 1 depicts in a block diagram an illustrative system for categorizing web pages used in an advertising environment. The environment 100 includes a plurality of interacting computer systems. Although the details of the individual computing systems are not depicted, it will be appreciated that they comprise at least a processing unit for executing instructions and memory unit for storing information including the instructions to be executed by the processing unit. The instructions when executed configure the computing systems to provide the components and functionality described further herein. Although the various computing systems are depicted as an individual component, it is contemplated that the functionality described may be provided by multiple computing systems.

As depicted in FIG. 1, the environment 100 includes a requester computer 102 that is coupled to an Internet Service Provider (ISP) 104. The ISP 104 provides access to the Internet 106 to the requester computer 102. Typically, the requester computer 102 will be located in a household associated with an ISP account for providing internet access to the household. The ISP account may provide internet access to a plurality of computing devices through a shared access point or access device such as a modem. The ISP 104 may be connected to other components including an advertisement (ad) provider 108 and a web mapping system 110 that can categorize web pages as described further herein. Although depicted as being connected to the ISP 104, the ad provider 108 and the web mapping system 110 may communicate with the ISP 104 via the Internet 106. The ISP 104 is depicted as a wire-line ISP, such as a cable or telephone ISP. It is contemplated that the categorizer described further herein can also be used in various environments, including a wireless network operator environment.

The requester computer 102 communicates with the ISP 104 in order to receive content from a content source 112 coupled to the Internet 106. The content provided may be, for example, a web page that includes content to be displayed at the requester computer 102. The content may include an indication that an advertisement is to be retrieved from the ad provider 108 and displayed with the content.

As depicted in FIG. 1, the requester computer 102 provides a request to the ISP 104 indicating a URL of the content to be retrieved and displayed. The content associated with the URL is retrieved from the content source 112 and returned to the requester computer 102 in response to the request. The content may include an indication of an advertisement to be retrieved. For example, the indication may comprise a universal resource locator (URL) of the ad provider 108 from which the advertisement is requested. The URL may include information for use by the ad provider 108 in determining which advertisement to return. For example, the URL may comprise information on the requested content being displayed by the requester computer 102. Additional information that may be used by the ad provider 108 when determining the ad to provide may be included in the request for the ad URL. This additional may include for example an Internet Protocol (IP) address of the requester computer 102.

When displaying the content received from the content source 112, the requester computer 102 attempts to retrieve ad content from the indicated ad URL. The ad provider 108 receives the ad request, which is a request to retrieve content associated with the ad URL, and generates and returns an advertisement for display on the requester computer 102 along with the main content received from the content source 112.

The ad provider 108 may use profile information associated with the requester computer 102, or an ISP account of the requester computer 102 or the household of the requester computer 102, in order to provide an advertisement that is targeted based on the information requested by the requester computer 102. In order to update the profile based on the requested content, the ISP 104 requires an indication of how the requested content should affect the profile. As described further herein, a web mapping system 110 may be used to provide a characterization of the content requested by the requester computer based on a URL. As such, when a requester computer 102 requests a URL, in addition to retrieving the requested content, the ISP 104 may pass the URL to the web mapping system 110, which provides category information back to the ISP in response. The ISP may filter requested URLs received from the requester computer 102 that are used in determining a profile so that certain URLs are not categorized and do not affect the profile. For example, the ISP 104 may filter requests for URLs of the ad provider 108 since these URLs may not provide insight into the preferences of the requester.

Additionally or alternatively, if the ISP 104 does not provide a profile associated with a requester computer 102, the ad provider 108 may receive the URL of the content that is being displayed and pass the URL to the web mapping system 110. In response the web mapping system 110 can provide category information about the content to the ad provider 108. The ad provider 108 may use the category information to tailor the advertisement to be delivered based on the content. As will be appreciated, although the web mapping system 110 is depicted in an advertising environment, the web mapping system may be used in various environments in which it is desirable to determine categorization information of a URL.

As depicted in FIG. 1, the web mapping system 110 comprises a lookup component 114 that receives URLs to be categorized and returns a category result. The web mapping system 110 further comprises a categorization manager 116 that receives URLs and generates rules based on the URLs. The rules are stored in a rules database 118. As described further herein, the rules generated by the categorization manager 116 and stored in the rules database 118 are used by lookup component 114 when determining a category result for URLs. Each rule comprises a matching expression and associated categorization information. The matching expression of the rule is used in determining if the URL is a hit on the particular rule, and if it is, the associated category information of the particular rule is used in generating the category result.

The lookup component 114 uses various categorization algorithms to generate the category result for URLs. One or more of the categorization algorithms use the rules stored in the rules database 118 to generate the category result. Each rule stored in the rules database may be associated with one of the categorization algorithms. The categorization manager 116 comprises one or more rule-generation algorithms that generate the appropriate rules used by the categorization algorithms of the lookup component 114. When a categorization algorithm fails to generate a category result for a URL, the lookup component 114 may pass the URL to the categorization manager 116, which may then generate and store a rule based on the URL in the rules database 118. Additionally or alternatively, the categorization manager 116 may receive URLs to be categorized from external sources such as an administration console (not shown).

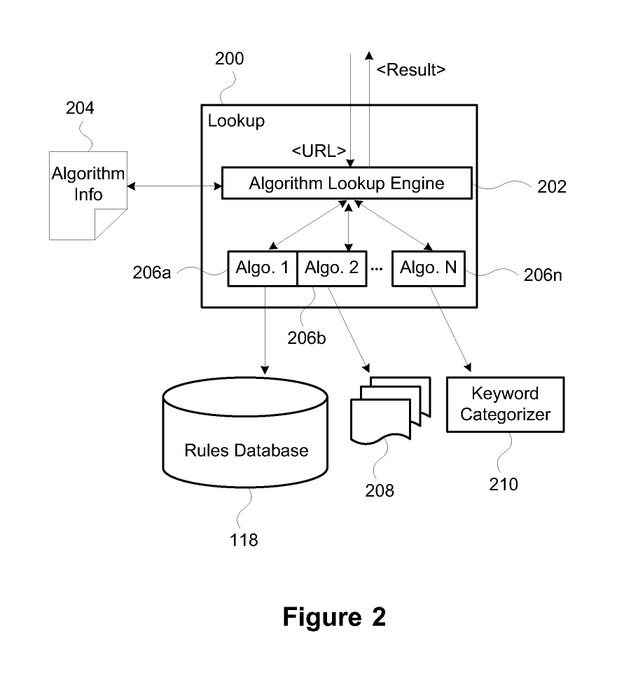

FIG. 2 depicts in a block diagram an illustrative lookup component that may be used in a system for categorizing web pages. The lookup component 200 may be used as the lookup component 114 of FIG. 1. The lookup component 200 comprises an algorithm lookup engine 202 that receives a URL, retrieves one or more categorization algorithms and successively applies the categorization algorithms to the URL until a category result is returned, or until there no further categorization algorithms to apply. The algorithm lookup engine 202 may access algorithm information 204 stored in a list or other structure. The algorithm information 204 specifies one or more available categorization algorithms that can be applied to the URL as well as an order to successively apply the categorization algorithms in.

The lookup component 200 further comprises one or more categorization algorithms 206a, 206b, 206n (referred to collectively as categorization algorithms 206). The algorithm lookup engine 202 may load the categorization algorithms 206 specified in the algorithm information 204 from a repository (not shown). The algorithm lookup engine 202 applies the first categorization algorithm to the URL and if a category result is returned no further categorization algorithms 206 are applied. However, if no category result is returned, the algorithm lookup engine successively applies the next categorization algorithm to the URL as indicated by the algorithm information 204. The algorithm lookup engine 202 continues to successively apply categorization algorithms 206 until a category result is returned or until there are no further categorization algorithms 206 left to apply.

As described above, each of the categorization algorithms 206 receives a URL that is to be categorized and returns an associated category result, or an indication that the categorization algorithm cannot categorize the URL. Each of the categorization algorithms 206 may attempt to determine the category result for a URL in different ways. As depicted in FIG. 2, categorization algorithm 1 206a uses rules stored in the rules database 118 to generate category results for URLs based on categorization information associated with the URL through the rules. Categorization algorithm 2 206b uses a list 208 that comprises one or more rules to generate category results for URLs. The rules stored in the list 208 are similar to the rules stored in the rules database 118; however, as described further herein the rules of the rules database 118 are automatically generated from a categorization manager, such as categorization manager 116, whereas the rules of the list 208 may be manually maintained.

In addition to the rules based algorithms, which compare URLs to a matching expression of a rule until a hit occurs between the URL and the matching expression of the rule and then returns the associated categorization information, there may be categorization algorithms that do not use rules to generate the category result. For example, categorization algorithm n 206n is depicted as using a keyword categorizer component 210. The keyword categorizer component 210 receives one or more keywords and provides associated categorization information based on the keywords. Categorization algorithm 206n may extract keywords from the URL to be sent to the keyword categorizer component 210, and generate the category result based on the received category information associated with the keywords.

Regardless of the methods used by the different categorization algorithms 206, each one attempts to provide a category result for a URL. The category result may comprise the categorization information associated with the URL, or may be based on the categorization information.

The categorization information for a URL may specify one or more categories from a plurality of predefined categories and an associated score indicating a relevance of the category to the URL. The predefined categories may be—arranged in a hierarchy of categories. For example, a hierarchy of automobiles, makers and models may be provided. Each of the categories may be associated with a unique number for use in identifying the category in the categorization information. It is contemplated that at least one of the categories is a blank category that can be used when providing a category result associated with a URL that is not to be classified.

The ability of the lookup component 200 to successively apply different categorization algorithms according to the algorithm information allows the lookup component 200 to efficiently categorize URLs. For example, the order in which the categorization algorithms are successively selected and applied may be set such that categorization algorithms with low processing complexity are selected first, while categorization algorithms having a higher processing complexity may be selected last. As a result of the possible ordering, the categorization algorithm having the higher processing complexity may be run less frequently, since the previous categorization algorithms will have successfully categorized the URL. The lookup component 200 may be able to process a large volume of URLs. For example, it may be able to process URLs received from one or more ISPs. As will be appreciated, the number of URLs requested from a single ISP may be large.

The ability of the lookup component 200 to successively apply different categorization algorithms provides additional flexibility in maintaining the web mapping system. New categorization algorithms, or updates to current categorization algorithms, may be introduced into the web mapping system by simply adding the required information to the algorithm information 204.

As described above, the algorithm lookup engine 202 may use one of a plurality of categorization algorithms. The categorization algorithms may categorize URLs in different ways. For example, some categorization algorithms may be list based algorithms, some categorization algorithms may be crawling based algorithms while some may be real-time categorization algorithms.

List-based categorization algorithms may include, for example, a white list categorization algorithm and a black list categorization algorithm. A white list may be used for manually specifying categorization information associated with one or more URLs. A black list is similar to the white list, however the categorization information would be for example a blank category. Each of the list-based categorization algorithms may use one or more lists that include one or more rules. As described above, each of the rules may comprise a matching expression and associated categorization information. The matching expression may be expressed using regular expressions (regex) in order to provide flexibility in successfully comparing a URL to the matching expression. For example, the two URLs example.com and www.example.com may refer to the same content and as such should be treated the same. The regex: ̂(www\.)??example\.com would result in a hit on both URLs. It will be appreciated that the specific regex to use will depend on the regex processing engine used as well as the URLs that are desired to produce a hit on the regex. An example of a rule for a list-based categorization algorithm is:

̂(www\.)??example\.com(/.*?\.html)? categoryID₁:0.5;categoryID₂:0.1

The above rule would provide the category information “categoryID1:0.5;categoryID2:0.1” for example.com and any URLs in the www.example.com domain that end in “.html”. For example the URLs www.example.com and example.com/someDirectory/content.html would result in a hit on the above rule and as such a list-based algorithm would return the associated category information. In contrast the URLs www.example.com/someDirectory/image.gif and example.org would result in a miss on the above rule, and assuming there were no other rules, a list-based algorithm would indicate that the URL resulted in a miss.

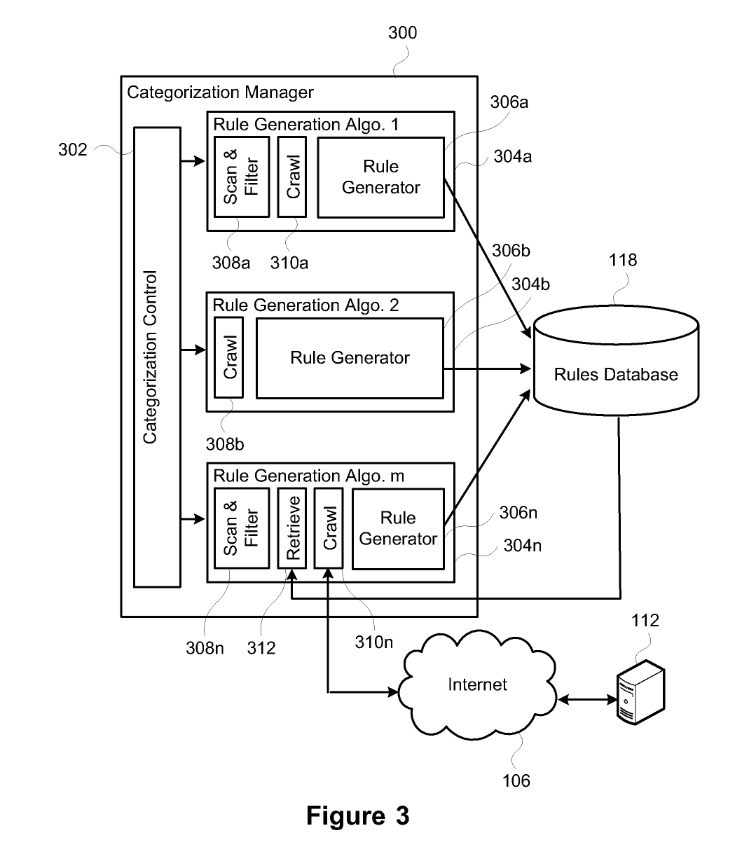

Crawling-based algorithms are similar to the list-based algorithms in that the algorithms utilize rules comprising a matching expression and one or more category:score pairs indicating a relevance of the URL to the respective category. However, unlike the list-based algorithms which use manually created rules, the rules used by the crawling-based algorithms are generated by the categorization manager described further with reference to FIG. 3. Since the rules associated with the crawling-based algorithms are automatically generated, there will typically be many more rules than for list-based algorithms, and as such, the rules may be stored in a database or other structure to facilitate fast storage and retrieval of the rules. Additionally, since the rules for crawling-based algorithms may be generated automatically, it is possible to request that a rule be generated for a particular URL. As such, when a crawling-based algorithm does not generate a category result for a particular URL, that is the URL does not match any of the matching expressions of the rules associated with the crawling-based algorithm, the algorithm may pass the URL onto the categorization manager in order to generate a rule with associated categorization information for the URL.

It is possible to have various crawling-based algorithms. For example, one crawling-based algorithm may provide an exact match between the rules' matching expression and the URL. That is, in an exact match algorithm, each matching expression of a rule will match with only a single URL. For example, a rule associated with an exact match algorithm may be:

www. example.com/directory1/content.html categoryID₁:0.8

The example rule above will only provide a hit for the URL “www.example.com/directory1/content.html” It will miss URLs such as “www.example.com/directory2/content.html”, “www.example.org/directory1/content.html” or “www.example.com”.

As a further example of crawling-based algorithms, a longest-prefix matching algorithm attempts to provide a category result based on the longest, categorizable URL under a domain that matches the URL being categorized. The longest prefix match algorithm allows the same category information to be associated with any URL that is located below the directory or location in the rule's matching expression. For example, two longest prefix match rules could be:

| | |
|---|---|
| www.example.com/directory1/directory1a | categoryID: 0.6 |
| www.example.com/directory2 | categoryID: 0.5 |

From the above rules any URLs that begin with “www.example.com/directory1/directory1a” will be associated with the category information categoryID:0.6. For example the URL “www.example.com/directory1/directory1a/additionalDirectoy/content.html” would be associated with the category information categoryID:0.6. While the URL “www.example.com/directory2/content.html” would be assigned the category information categoryID:0.5. From the above rules, the longest prefix match algorithm would not return a category result that is all of the rules would miss, on the URL “www.example.com”.

If the longest prefix match algorithm applies the rules in an order based on the depth of the directories in the matching expressions, that is, it applies rules having the most directories in the matching expression first, it is possible to have overlapping rules that have a common directory. For example, the two rules are possible:

| | |
|---|---|
| www.example.com/directory1/directory1a | categoryID: 0.6 |
| www.example.com/directory1 | categoryID: 0.5 |

The rules may include additional information regarding the depth of the directories in the matching expression in order to facilitate applying the rules in an order to allow overlapping rules as described above. Additionally, the domain of a URL may be used as a key to retrieve relevant rules from the database. For example, if the domain of the URL is www.example.com there is no need to consider rules associated with the domain www.example.org. If the domains are used as a key, it is possible to store the domain in reverse order, which can increase the retrieval speed. For example, the key for the domain www.example.org could be stored as org.example.www.

The above has described the rules associated with the crawling-based algorithms as being stored individually in a database. However, it is contemplated that the rules could be grouped together, for example by domain, and stored as a single entry associated with the domain. Since each rule can be specified as a string, it is possible to store rules as separated strings in various ways. One skilled in the art will appreciate that there are numerous options available for the efficient storage and retrieval of rules.

In addition to the list-based algorithms and the crawling-based algorithms described above, it is also possible for the lookup engine 202 to use real-time categorization algorithms. An example of a real-time categorization algorithm may provide categorization based on terms in the URL. For example, a shopping web site may allow a user to search for items. The items that are being searched for may appear at known locations in the URL. A real-time categorization algorithm may extract these search terms and pass them to a keyword categorization component, which maps the keywords to one or more category:score pairs. The extraction of the keyword terms and the mapping between the keyword terms and category information may be done quickly so as to provide real-time or near real-time categorization of the URL. By way of example, to search for items a shopping website may use a URL pattern model associated with the domain such as:

www.example.com/shopping/Search?terms=keyword1+keyword2

Where keyword1 and keyword2 are the keyword terms that are being searched for. A real-time categorization algorithm may use one or more URL pattern models that indicate how to extract keyword terms from the URL. Once the keyword terms are extracted they are provided to a keyword categorization component, which provides categorization information based on the keywords.

Real-time categorization algorithms may also be used when there is no URL pattern model indicating the known location of keywords. For example, it is possible to parse the URL into words to be used as keywords, which are then provided to the keyword categorization component 210.

As described above, some categorization algorithms may use rules that are automatically generated. When the categorization algorithm misses on a URL, that is there is no rule having a matching expression that matches with the URL, the URL may be provided to a categorization manager in order to generate a rule associated with the URL.

FIG. 3 depicts in a block diagram an illustrative categorization manager that may be used in a system for categorizing web pages. The categorization manager 300 may be used as the categorization manager 116 of FIG. 1. The categorization manager 300 receives one or more URLs and generates and stores one or more rules based on the URLs. The URLs may be received from various locations or components. For example, the URLs may be received from a lookup component as described above, or they may be submitted from an external component such as an administration console. The URLs may be submitted individually or in batches. Regardless of how the URLs are received, the categorization manager 300 processes the received URLs and generates one or more rules from the URLs.

As described above, the lookup component may have one or more crawling-based algorithms that use rules generated by the categorization manager 300. The categorization manager 300 may similarly comprise one or more corresponding rule-generation algorithms that generate rules that can be used by crawling-based categorization rules. For example, as described above, two illustrative crawling-based categorization algorithms are an exact-match algorithm and a longest prefix match algorithm. In such an example, the categorization manager 300 may comprise an exact-match rule-generation algorithm and a longest-prefix match rule-generation algorithm.

As depicted in FIG. 3, the categorization manager 300 comprises a categorization control component 302 and one or more rule-generation algorithms 304a, 304b, 304n (referred to collectively as rule-generation algorithms 304). The categorization control component 302 receives URLs and controls the overall functioning of the categorization manager. For example, the categorization control component 302 may provide the received URLs to the one or more rule-generation algorithms for processing. It is possible for the categorization control component 302 to provide the same URL or URLs to different rule-generation algorithms for processing. For example, a URL that was received due to a miss from an exact match categorization algorithm may be provided to an exact match rule-generation algorithm. If the same URL subsequently missed on a longest-prefix match categorization algorithm, it could also be provided to a longest-prefix match rule-generation algorithm. It is contemplated that the rule-generation algorithms may process the various URLs in parallel with each other. It is further contemplated that the categorization control component 302 may provide the URLs to one rule-generation algorithm for processing prior to passing the same URLs to another rule-generation algorithm for further processing. Regardless of whether the individual rule-generation algorithms are executed in parallel or sequentially, each rule-generation algorithm generates one or more rules for the URLs and stores the generated rules in the rules database 118.

As depicted in FIG. 3, each of the rule-generation algorithms 304 comprise a rule generator component 306a, 306b, 306n (referred to rule generator component 306 generally) that generates the rules according to the requirements of the categorization algorithm the rules will be used with. For example rule generator component 306a may generate rules used by the exact match categorization algorithm, and rule generator component 306n may generate rules used by the longest prefix match categorization algorithm. The specific functionality provided by each rule generator component 306 may vary; however, will typically comprise functionality for determining one or more categories from a plurality of predefined categories that are relevant to the content referenced by the URL being categorized and a respective score associated with the one or more determined categories.

The rule generator components 306 may also generate the appropriate matching expression for the rules. In the case of rules for the exact match categorization algorithm, the matching expression is the specific URL being categorized.

As depicted in FIG. 3, each of the rule-generation algorithms may further include additional components such as a scan and filter component 308a, 308n, (referred to as scan and filter components 308 collectively) a crawling component 310a, 310b, 310n (referred to as crawling components 310 collectively) and/or a retrieval component 312. It is noted that the crawling components 310a, 310b are not depicted as communicating with content source 112 via the internet 106 for clarity of the drawing. The crawling components 310a, 310b would retrieve content from the content source 112 via the internet 106.

The scan and filter components 308 may scan the received URLs and filter out any URLs that should not be processed by the corresponding rule generator components 306. For example, the received URLs may be scanned to determine if a corresponding URL has been processed recently, and as such shouldn't be processed again. Further, URLs that are not to be categorized may be filtered out.

Once the URLs to be processed by the rule generators 306 are determined, the URLs may be passed to a crawling component, which crawls the URLs. The type of crawling performed may be based on the type of rule-generation algorithm the crawling is done for. For example, a deep crawl may be performed in which, URL links embedded within the content are followed and the linked to content retrieved. This linking content retrieval may be continued for a number of links. A fast crawl may be performed that does not retrieve the content from embedded links. Additionally, a retrieval component 312 may be used to check to see if any rules are currently associated with URLs and if there are, the categorization information may be retrieved and the crawling would not need to be performed on the URLs for which the categorization information was retrieved. For example, for a longest-prefix match rule-generation algorithm, rather than crawling all of the URLs, it may first check to see if any of the URLs have been categorized for another categorization algorithm, such as an exact match categorization algorithm. If there are existing rules for the URL or URLs, the retrieval component 312 of the rule-generation algorithm may retrieve the category information from the existing rules in stead of crawling the URL.

Once the URLs have been crawled, the content is processed by the rule generator components to generate one or more category:score pairs. In the case of the exact match rule-generation algorithm, each URL processed results in a corresponding rule. In contrast, the longest prefix match rule-generation algorithm attempts to group common URLs together by their directory structure and provide one or more category:score pairs to the common directory structure of the URLs.

As described above, the categorization manager 300 receives one or more URLs, and generates one or more rules, including a matching expression and associated categorization information, that are stored in the rules database 118 for subsequent use by one or more of the categorization algorithms.

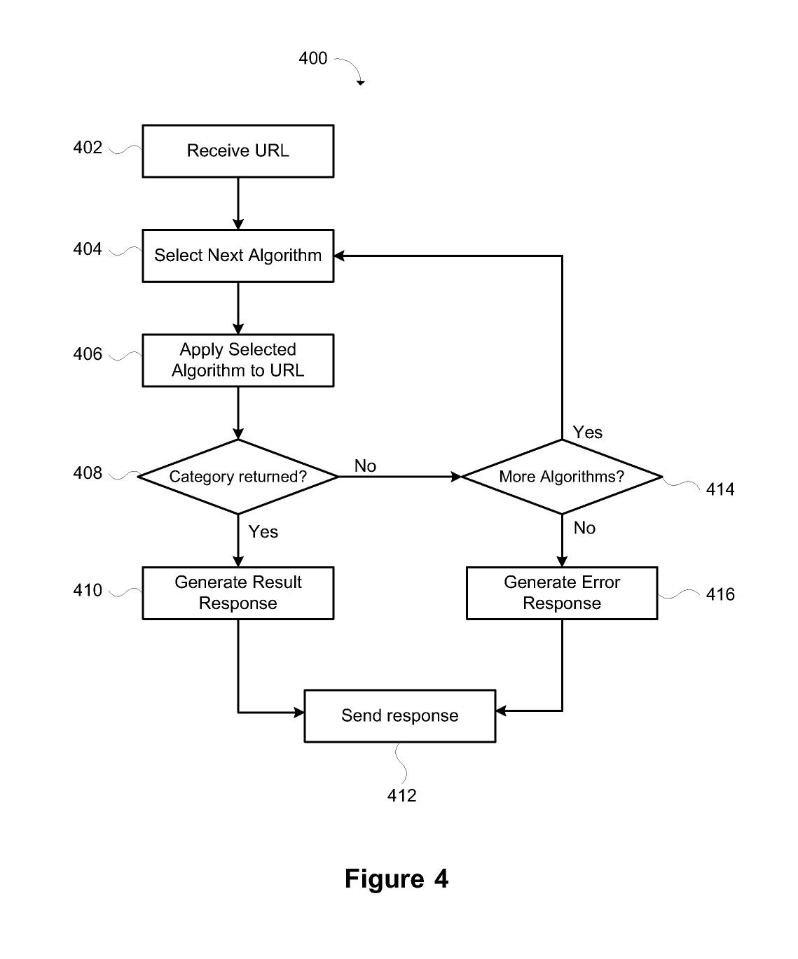

FIG. 4 depicts in a flow chart an illustrative method of categorizing web pages. The method 400 may be performed by the lookup component described above, or by other components in order to provide web page categorization functionality. The method receives a URL (402). The URL may be submitted by various external components or systems, such as an ISP, advertiser network, etc, which desire a category result associated with the URL. The category result may be used for various purposes, such as tailoring an advertisement to the content of the web page the ad will be displayed on, updating a profile of a requester that has requested the URL, etc. Once the URL is received, a next categorization algorithm is selected (404) from a plurality of categorization algorithms. If no categorization algorithm has been applied to the URL yet, a first categorization algorithm is selected as the next categorization algorithm from the plurality of categorization algorithms. Information regarding the plurality of categorization algorithms that may be applied to URLs as well as the order they should be selected and applied in may be stored in a list or file or other structure.

After the next algorithm has been selected, it is applied to the URL (406). As described above, each categorization algorithm that receives a URL provides either a category result associated with the received URL or an indication that no category result could be determined for the received URL. After applying the selected categorization algorithm to the URL it is determined if a category result was returned (408). If a category result was returned (Yes at 408), a result response is generated (410) and returned (412) to the component or system that provided the requested URL. If after applying the selected categorization algorithm to the URL it is determined that no category result was returned (No at 408), it is determined if there are more categorization algorithms to apply (414). If there are more categorization algorithms to apply (Yes at 414) the next categorization algorithm is selected (404) and applied (406). If there are no more categorization algorithms (No at 414) an error response is generated (416) indicating that no category result could be associated with the requested URL and returned (412).

By using a plurality of categorization algorithms that are successively applied to a URL it is possible to balance the quality of the category result returned with the processing overhead required to generate the category result. For example, the exact match algorithm may provide the most accurate category result for an individual web page, however the processing overhead required to apply the exact match categorization algorithm to each URL may be undesirably high. By using additional categorization algorithms such as the white list or black list it is possible to provide categorization information that is of sufficient quality while reducing the processing overhead required to generate the category result. As a result of successively applying the categorization algorithms it is possible to reduce the number of URLs processed by categorization algorithms that have a high processing overhead while still ensure the quality of the category result returned.

Additionally, the use of crawling-based categorization algorithms, which generate categorization information for a URL based on rules, allows the web mapping system to be implemented as a distributed system, providing for greater scalability. The rules, which may be a simple text string can be easily transferred between the components of the distributed system.

The web mapping system 110 was described above as being a single system. It is contemplated that the single web mapping system can be implemented on a plurality of computers or servers in order to provide the processing performance required to process a particular number of URL requests in a given period of time.

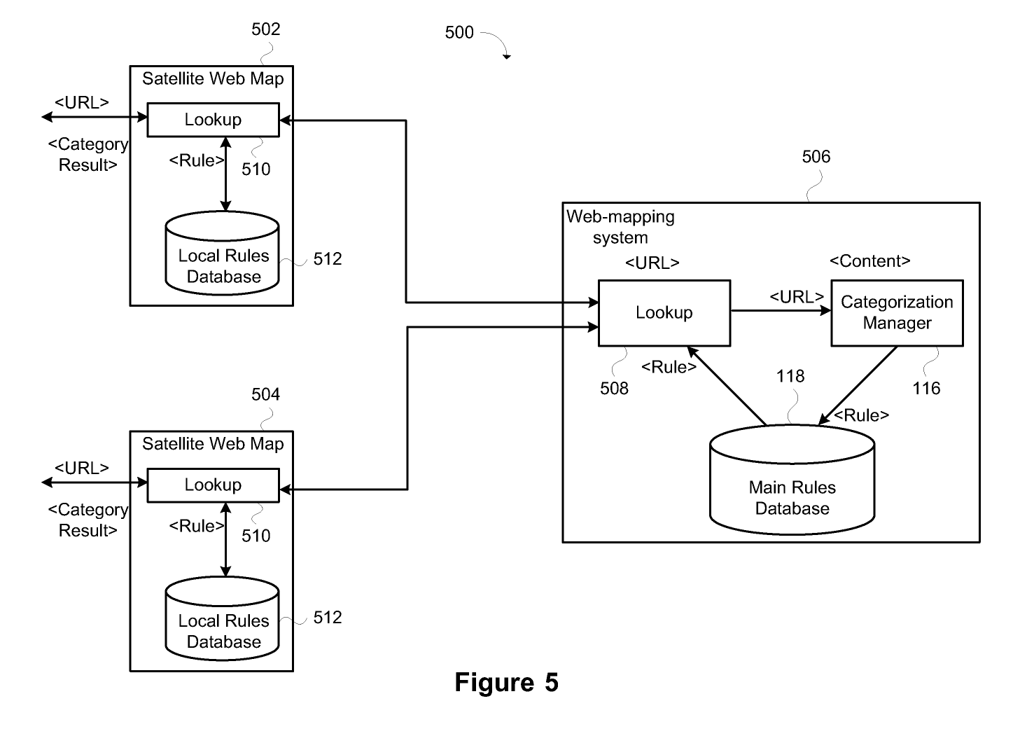

FIG. 5 depicts in a block diagram a distributed system for categorizing web pages. The distributed system is similar to the web mapping system 100 described above, however the lookup functionality provided by the lookup component 114 may be distributed to different satellite web mapping systems 502, 504. Each satellite web mapping system 502, 504 may be located in different geographic locations, or may be located in different ISPs' networks.

The distributed web map system 500 comprises one or more satellite web map systems 502, 504 and a main web map system 506. The main web map system 506 is substantially similar to the web map system 100, however in addition to processing URLs, the lookup component 508 may also receive and process rule requests received from one or more of the satellite web map systems 502, 504. A rule request may indicate a URL for which a rule is requested. The rule request may also specify the categorization algorithm the rule is to be used with. The lookup component 508 retrieves the appropriate rule from the rules database and returns it to the requesting satellite web map system 502, 504 if it exists. If the requested rule does not exist in the main rules database 118, the lookup component 508 may provide the URL associated with the rule request to the categorization manager 116 for subsequent rule generation. If the lookup component 508 could not retrieve the rule, an error may be returned to the requesting satellite web map system 502, 504 indicating that no rule was found.

Each satellite web map system 502, 504 comprises a lookup component 510 and local rules database 512. The lookup component 510 functions substantially the same as the lookup component 114 described above. However, when a crawling-based categorization algorithm is unsuccessful in generating a category result for a URL, that is the URL results in a miss, the lookup component 510 sends a rule request to main web map system 506. The lookup component 510 may then proceed to the next categorization algorithm. If the requested rule is found in the main rules database it is returned to the satellite web map system and stored in the local rules database. As a result, the next time the URL is requested, the local rule database will have an associated rule. It is contemplated that rather than proceeding to the next categorization algorithm upon a miss, the categorization algorithm may wait for a rule to be returned; however, it is noted that this may require the categorization algorithm waiting for a period of time due to the communication between the satellite and main web map systems, as well as any delay in retrieving the rule at the main web map system.

The use of the rules by the crawling-based categorization algorithms allows the web mapping system to be easily implemented as a distributed system. The rules may be represented by a simple short string which can be easily and quickly transmitted between a satellite web map system and a main web map system.

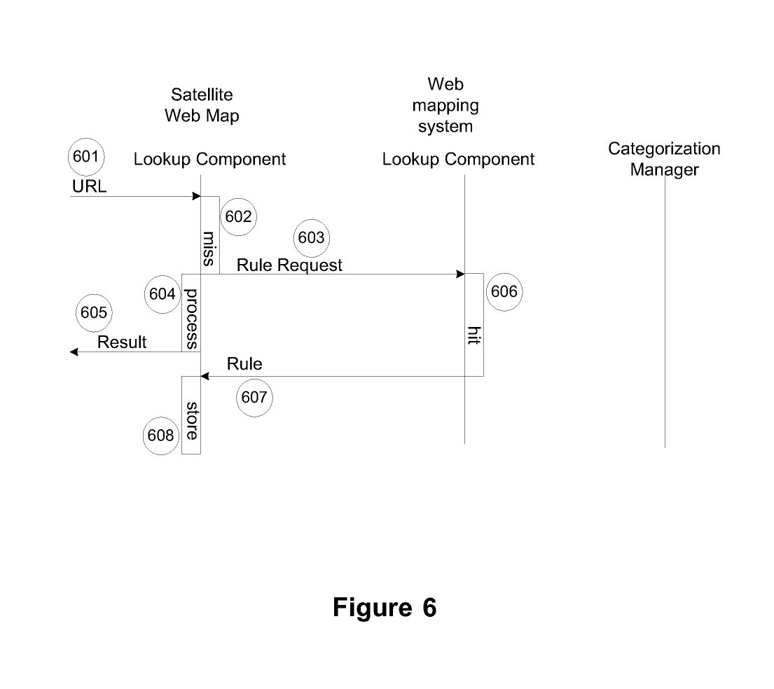

FIG. 6 depicts in a process flow diagram an illustrative categorization process in a distributed system for categorizing web pages. A URL is received at lookup component of a satellite web map system (601) and the lookup component processes the URL using the categorization algorithms. The example depicted in FIG. 6 assumes that a crawling-based categorization algorithm is applied. After receiving the URL, the lookup component of the satellite web map system applies a crawling based categorization algorithm to the URL. The lookup component fails to match the URL to any of the locally stored rules (602). Once the crawling-based categorization algorithm misses on the URL, a rule request is sent to the main web map system (603) and the lookup component continues processing the URL (604) using another categorization algorithm and generates a categorization result (605). The lookup component of the main web map system receives the rule request and retrieves an appropriate rule from the main rule database (606) and returns the rule to the requesting satellite web map system (607), which stores the rule in the local rules database (608) so that the next time the URL is processed it will result in a hit.

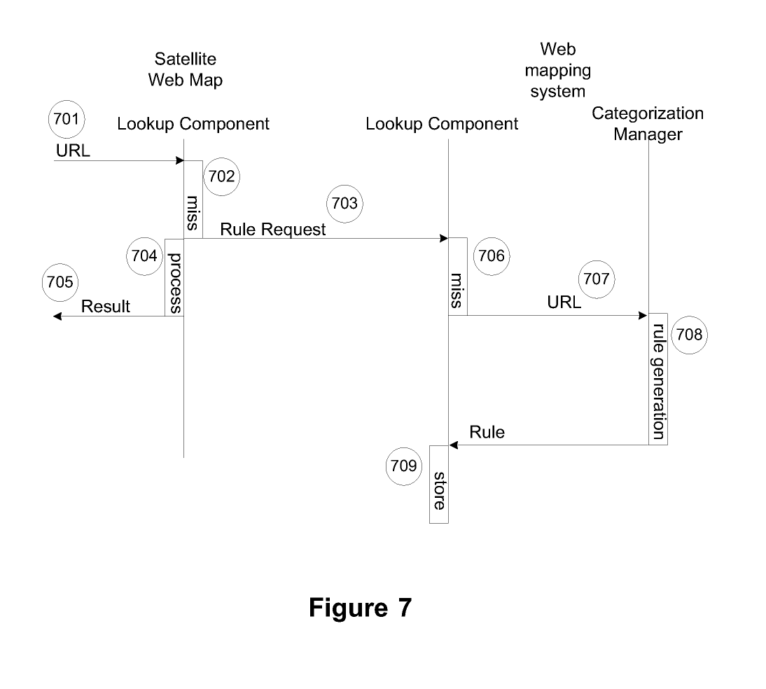

FIG. 7 depicts in a process flow diagram a further illustrative categorization process in a distributed system for categorizing web pages. The process is similar to that of FIG. 6, however depicts what happens when the main web map system does not retrieve a rule. A URL is received at lookup component of a satellite web map system (701) and the lookup component processes the URL using the categorization algorithms. The example depicted in FIG. 7 assumes that a crawling-based categorization algorithm is applied. After receiving the URL, the lookup component of the satellite web map system applies a crawling based categorization algorithm to the URL. The lookup component fails to match the URL to any of the locally stored rules (702). Once the crawling-based categorization algorithm misses on the URL, a rule request is sent to the main web map system (703) and the lookup component continues processing the URL (704) using another categorization algorithm and generates a categorization result (705). The lookup component of the main web map system receives the rule request and attempts to retrieve an appropriate rule from the main rule database (706). However the main lookup component fails to retrieve a rule and as such the URL associated with the rule request is passed to the categorization manager (707), which then generates a rule (708) based on the URL and stores the rule in the main rules database (709). Once the rule is stored it the next time a satellite web map system requests the rule it will be returned as described above with reference to FIG. 6.

The systems and methods described above provide the ability to provide category information for web pages based on their URLs. The system and methods described herein have been described with reference to various examples. It will be appreciated that components from the various examples may be combined together, or components of the examples removed or modified. As described the system may be implemented in one or more hardware components including a processing unit and a memory unit that are configured to provide the functionality as described herein. Furthermore, a computer readable memory, such as for example electronic memory devices, magnetic memory devices and/or optical memory devices, may store computer readable instructions for configuring one or more hardware components to provide the functionality described herein.

The systems and methods have been described above as providing category information based on a received URL. It is also contemplated that the system could use any content pointer that can be used to describe the location of content to be retrieved. For example, a Universe Resource Identifier (URI) may also be used to specify the content to be categorized.

Furthermore, the above description has described the URL, or the content pointer, of the content to be categorized as being provided from a requestor computer. It is contemplated that the content pointer associated with the content to be categorized can be received from numerous various devices. For example, the requesting computer could be a mobile device such as smart phone. Further, the content pointer does not need to be requested from a device accessing the content, but may be any device or service that desires to receive categorization information associated with a content pointer.

What is claimed is:

1. A system for categorizing web pages comprising:
a memory unit for storing instructions; and
a processing unit for executing instructions stored in the memory unit, the instructions, when executed by the processing unit configuring the system to provide:
a plurality of rules, each rule comprising a matching expression and associated categorization information;
a plurality of categorization algorithms, each of the categorization algorithms for providing a category result for a content pointer indicating a particular content according to one of the plurality of rules, the category result based on categorization information of a rule having a matching expression that matches the content pointer; and
a lookup component for receiving a requested content pointer and successively selecting a categorization algorithm from the plurality of categorization algorithms to apply to the requested content pointer until one of the plurality of categorization algorithms provides a category result for the content pointer.

2. The system of claim 1, wherein the category result comprises an identifier of one or more predefined content categories and an associated score indicating a relevance of each of the respective one or more predefined categories to the content pointer.

3. The system of claim 1, further comprising:
a rules database storing one or more of the plurality of rules; and
a categorization manager for receiving a categorization content pointer, generating a rule based on the categorization content pointer and storing the generated rule in the rules database for subsequent use by at least one of the plurality of categorization algorithms.

4. The system of claim 3, wherein the categorization manager receives a plurality of categorization content pointers and generates at least one rule based on the received plurality of categorization content pointers, wherein the categorization manager retrieves content associated with the plurality of categorization content pointers and applies one or more rule-generation algorithms to the categorization content pointers and the associated retrieved content to generate the at least one rule, and wherein the categorization manager generates the matching expression of the generated at least one rule based on the plurality of categorization content pointers and generates the categorization information based on the associated retrieved content.

5. The system of claim 1, further comprising:
a categorization manager for receiving categorization content pointers, generating rules based on the categorization content pointer according to one or more rule-generation algorithms and storing the generated rules for subsequent use by at least one of the plurality of categorization algorithms,
wherein the one or more rule-generation algorithms include:
an exact match rule-generation algorithm generating a rule for each categorization content pointer, each generated rule comprising:
a matching expression corresponding to the exact categorization content pointer; and
categorization information generated based on the retrieved content associated with the categorization content pointer; and
a longest prefix match (LPM) rule-generation algorithm for grouping together a plurality of categorization content pointers sharing a common content pointer path and generating a single rule comprising:
a matching expression that will match the plurality of categorization content pointers sharing the common content pointer path; and
categorization information based on the content associated with the plurality of categorization content pointers sharing the common content pointer path.

6. The system of claim 1, wherein the plurality of categorization algorithms comprise one or more:
list based categorization algorithms for determining the category result using a predefined list of rules; and
crawling categorization algorithms for determining the category result using one or more rules generated from crawling a plurality of content pointers, wherein:
the list based categorization algorithms comprise one or more of:
a white-list categorization algorithm returning the content pointer profile based on a white list of regular expressions and associated content pointer profiles, the white-list categorization algorithm returning the content pointer profile associated with the regular expression from the white list matching the received content pointer; and
a black-list categorization algorithm returning an empty content pointer profile if the received content pointer matches a regular expression of a black list comprising a plurality of regular expressions of content pointers not to be categorized; and
the crawling based categorization algorithms comprise one or more of:
a longest prefix match (LPM) categorization algorithm returning the category result when the received content pointer has a path in common with a content pointer of an LPM rule stored in the rule database; and
an exact match categorization algorithm returning the category result when the received content pointer is an exact match to a content pointer of an exact match rule stored in the rule database.

7. The system of claim 6, wherein if a crawling categorization algorithm does not return a category result for the requested content pointer, the requested content pointer is passed to the categorization component.

8. The system of claim 1, further comprising one or more real-time categorization algorithms that each can be selected by the categorization manager when successively selecting the categorization algorithm from the plurality of categorization algorithms, the real-time categorization algorithm for generating the category result based on the requested content pointer.

9. The system of claim 8, wherein:
the real-time categorization algorithms comprise one or more of:
a search term categorization algorithm for identifying search terms in the received content pointer and generating a categorization for the content pointer profile based on the identified search terms; and
a content pointer categorization algorithm for identifying terms in the received content pointer and generating a categorization for the content pointer profile based on the identified terms.

10. A method for categorizing web pages comprising:
receiving a content pointer request for categorization;
selecting a first categorization algorithm from a plurality of categorization algorithms, each of the categorization algorithms for providing a category result for a content pointer according to one of a plurality of rules, each rule comprising a matching expression and associated categorization information;
applying the selected first categorization algorithm to the requested content pointer;
determining if the selected first categorization algorithm provided a category result for the requested content pointer; and
selecting an other categorization algorithm to apply to the requested content pointer when it is determined that the first categorization algorithm did not provide the category result.

11. The method of claim 10, wherein the category result comprises an identifier of one or more predefined content categories and an associated score indicating a relevance of each of the respective one or more predefined categories to the content pointer.

12. The method of claim 11, further comprising:
generating a rule based on the requested content pointer when it is determined that the first categorization algorithm did not provide the category result; and
storing the generated rule in the rules database for subsequent use by at least one of the plurality of categorization algorithms.

13. The method of claim 12, further comprising:
receiving a plurality of categorization content pointers;
retrieving content associated with the plurality of categorization content pointers;
applying one or more rule-generation algorithms to the categorization content pointers and the associated retrieved content to generate the at least one rule; and
generating at least one rule based on the received plurality of categorization content pointers comprising:
generating the matching expression of the generated at least one rule based on the plurality of categorization content pointers; and
generating the categorization information based on the associated retrieved content.

14. The method of claim 10, further comprising:
receiving categorization content pointers;
generating rules based on the categorization content pointer according to one or more rule-generation algorithms; and
storing the generated rules for subsequent use by at least one of the plurality of categorization algorithms,
wherein the one or more rule-generation algorithms include:
an exact match rule-generation algorithm generating a rule for each categorization content pointer, each generated rule comprising:
a matching expression corresponding to the exact categorization content pointer; and
categorization information generated based on the retrieved content associated with the categorization content pointer; and
a longest prefix match (LPM) rule-generation algorithm for grouping together a plurality of categorization content pointers sharing a common content pointer path and generating a single rule comprising:
a matching expression that will match the plurality of categorization content pointers sharing the common content pointer path; and
categorization information based on the content associated with the plurality of categorization content pointers sharing the common content pointer path.

15. The method of claim 10, wherein the plurality of categorization algorithms comprise one or more:
list based categorization algorithms for determining the category result using a predefined list of rules; and
crawling categorization algorithms for determining the category result using one or more rules generated from crawling a plurality of content pointers.

16. The method of claim 15, wherein:
the list based categorization algorithms comprise one or more of:
a white-list categorization algorithm returning the content pointer profile based on a white list of regular expressions and associated content pointer profiles, the white-list categorization algorithm returning the content pointer profile associated with the regular expression from the white list matching the received content pointer; and
a black-list categorization algorithm returning an empty content pointer profile if the received content pointer matches a regular expression of a black list comprising a plurality of regular expressions of content pointers not to be categorized; and
the crawling based categorization algorithms comprise one or more of:
a longest prefix match (LPM) categorization algorithm returning the category result when the received content pointer has a path in common with a content pointer of an LPM rule stored in the rule database; and
an exact match generation algorithm returning the category result when the received content pointer is an exact match to a content pointer of an exact match rule stored in the rule database.

17. The method of claim 15, wherein if a crawling categorization algorithm does not return a category result for the requested content pointer, the requested content pointer is passed to the categorization component.

18. The method of claim 10, wherein the other categorization algorithm is a real-time categorization algorithm for generating the category result based on the requested content pointer.

19. The method of claim 18, wherein:
the real-time categorization algorithms comprise one or more of:
a search term categorization algorithm for identifying search terms in the received content pointer and generating a categorization for the content pointer profile based on the identified search terms; and
a content pointer categorization algorithm for identifying terms in the received content pointer and generating a categorization for the content pointer profile based on the identified terms.

20. The method of claim 10, further comprising:
successively selecting a categorization algorithm from the plurality of categorization algorithms to apply to the requested content pointer until one of the plurality of categorization algorithms provides the category result for the content pointer or until there are no more categorization algorithms to apply.

21. A computer readable memory comprising instructions for providing a method for categorizing web pages comprising:
receiving a content pointer request for categorization;
selecting a first categorization algorithm from a plurality of categorization algorithms, each of the categorization algorithms for providing a category result for a content pointer according to one of a plurality of rules, each rule comprising a matching expression and associated categorization information;
applying the selected first categorization algorithm to the requested content pointer;
determining if the selected first categorization algorithm provided a category result for the requested content pointer; and
selecting an other categorization algorithm to apply to the requested content pointer when it is determined that the first categorization algorithm did not provide the category result.
